(19) United States
(12) Patent Application Publication
(10) Pub. No.: US 2020/0230017 A1
(43) Pub. Date: Jul. 23, 2020

(54) SELF-BIASED MASSAGE DEVICE ACCESSORY

(71) Applicants: Christopher Hamilton Martin, Aspen, CO (US); Stacie June Martin, Aspen, CO (US)

(72) Inventors: Christopher Hamilton Martin, Aspen, CO (US); Stacie June Martin, Aspen, CO (US)

(21) Appl. No.: 16/748,488

(22) Filed: Jan. 21, 2020

Related U.S. Application Data
(60) Provisional application No. 62/918,183, filed on Jan. 19, 2019.

(51) Int. Cl. A61H 11/00

(52) U.S. Cl. CPC A61H 11/00; A61H 2201/1676; A61H 2201/1669; A61H 2201/1253

(57) ABSTRACT

Aspects of the disclosure provide a massage device accessory that can be used to generate a reciprocating motion for a massage device that is coupled with the massage device accessory. The massage device accessory may be a single-piece of substantially rigid material that has a L-shaped bend and provides for elastic deformation between a relaxed first position and a deformed second position. The accessory further includes a securement surface or sleeve for a massage device, and an aperture for a strap, where a force applied to the strap will deform the accessory to move one end from the first position toward the user at the second position, and release of the force will allow the accessory to revert to its original shape, such that repeated application and release of force on the strap results in a reciprocating motion of the massage device.

### CROSS-REFERENCE TO RELATED APPLICATIONS

The present application claims the benefit of Provisional Patent Application No. 62/918,183, filed on Jan. 19, 2019, the entire disclosure of which is incorporated herein by reference.

### FIELD OF THE INVENTION

The present invention relates generally health and wellness devices, and, more particularly, to a self-biased massage device accessory to which a massage device may be attached and that provides self-biased retraction in response to a pulling motion, to generate a reciprocating motion for the massage device.

### BACKGROUND OF THE INVENTION

Health and wellness is an increasingly important area for the focus of individuals seeking to have a happy and healthy life. Sexual wellness is increasingly believed to play an important part in a happy and healthy life, and sexual devices are increasingly accepted and important tools to help maintain overall wellness of individuals. Such devices may include simulated phallic devices that may be moved on or in the body to, and are in many cases held in the hand of a user, which may cause difficulty in achieving a desired angle or movement of the device.

### SUMMARY OF THE INVENTION

Aspects of the disclosure provide a massage device accessory that can be used to generate a reciprocating motion for a massage device that is coupled with the massage device accessory. In some aspects, the massage device accessory is a single-piece of substantially rigid material that has a L-shaped bend and a certain degree of elastic deformation. The accessory further includes a securement surface or sleeve for a massage device, and an aperture for a strap, where a force applied to the strap will deform the accessory to move one end toward the user and release of the force will allow the accessory to revert to its original shape, such that repeated application and release of force on the strap results in a reciprocating motion of the massage device. In some cases, each side of the accessory has a beveled or raduised edge.

In some cases, a massage device accessory apparatus is provided having a first end having a first massage device securement portion and one or more apertures; a second end having a second massage device securement portion and one or more apertures; and an elbow coupled with the first end and the second end. In some cases, the elbow, the first end, and the second end have a relaxed first form having an L-shape that is deformable through application of a force to one or more of the apertures to thereby create an elastic deformation to a second form and force a massage device secured to the first massage device securement portion in a first direction relative to a user of the accessory. The accessory is biased through the elastic deformation to return back to the relaxed first form upon removal of the force.

In some cases, the apparatus may also include a bridle threaded through the one or more apertures of the first end, and wherein the force is applied through pulling on the bridle. The bridle may include, for example, a scarf, cord, rope, or strap that is threaded through the one or more apertures of the first end. In some cases, the second end of the apparatus is configured to be secured relative to the user (e.g., under a cushion, pillow, or mattress) to allow for movement of the first end toward and away from a desired location of the user's body. In some case, a sleeve may be placed around the first end, and where the massage device is secured to the sleeve. In some cases, the first end, second end, and elbow are formed from a single piece of elastically deformable material. In some cases, the material comprises acrylic having a thickness between ⅛ inch and ⅜ inch, although any thickness of material that provides sufficient elastic deformation may be used. In some cases, the material comprises a metal that is elastically deformable.

In some cases, a hinge may be coupled between the first end and the elbow, where the first end is hangable toward the second end for transport and storage of the apparatus. In some cases, the hinge includes a latch to lock the apparatus into an open or closed position.

### BRIEF DESCRIPTION OF THE DRAWINGS

FIG. 1 is a perspective view of a massage device accessory in accordance with various aspects of the present disclosure;

FIG. 2 is a perspective view of a massage device accessory that illustrates the generating of a reciprocating movement the massage device in accordance with various aspects of the present disclosure;

FIG. 3 is an illustration of a hinged massage device accessory in accordance with various aspects of the present disclosure; and

FIG. 4 is an illustration of a massage device accessory with an external sleeve in accordance with various aspects of the present disclosure.

### DETAILED DESCRIPTION

For a more complete understanding of this invention, reference is now made to the following detailed description of several embodiments as illustrated in the drawing figures, in which like numbers represent the same or similar elements.

Various aspects of the present invention recognize the need for enabling reciprocating motion of a massage device with relatively little effort or discomfort of a user. While various aspects of the disclosure relate to sexual massage devices, techniques as discussed herein may be used for any type of massage device in which a user desires a reciprocating type of action or a sustained force that is easily released at a portion of their body, such as for back, neck, or leg massages using a massage device that stimulates myofascial release at a trigger point of the user's body that is generating muscle pain.

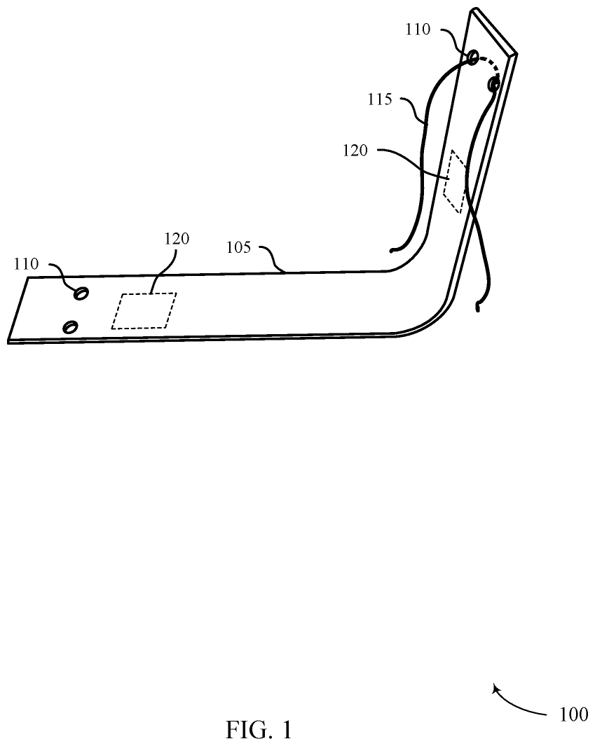

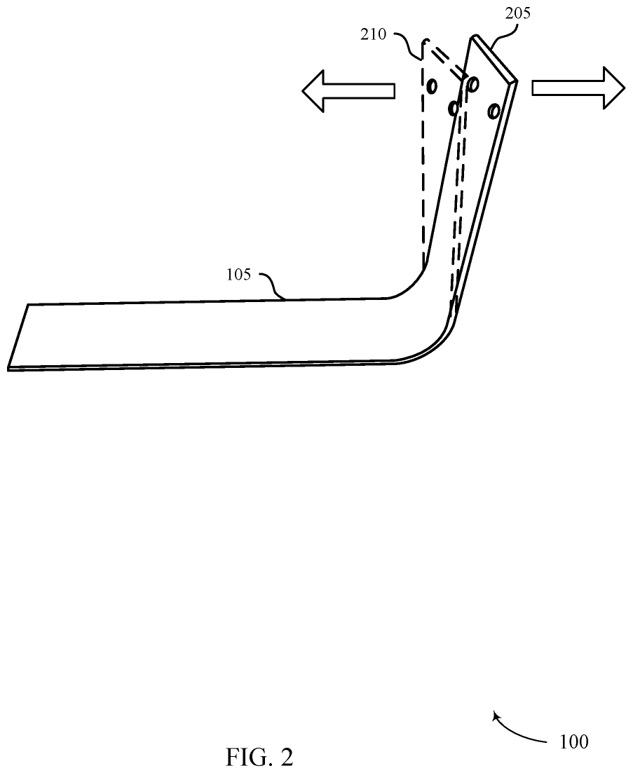

With reference to FIGS. 1 and 2, one example 100 of a message device accessory 105 is illustrated. In this example, the accessory 105 is a ¼″ acrylic or other polymer form, although any other suitable material that provides a bias back to an original placement. In the example of FIG. 1, a flat smooth surface 120 may be provided that assists in the placement of a suction cup massage device, and apertures 110 may allow a bridle 115 to be threaded through the end. With the massage device coupled with the accessory 105, a user may pull ends of the interchangeable bridle 115 to force the free end of the accessory 105 in a first direction from a first position 205 to a second position 210, as illustrated in FIG. 2. When the force is released, the free end of the accessory 105 may move back to its original first position 205, such that repeated applications and release of force results in a reciprocating motion of the massage device between the first position 205 and second position 210. The bridle 115 may also allow for various attachments to be used during operation, such as attachable feathers, clips, and small vibrators, and the like. In some cases, a scarf may be used as a bridle 115 by threading ends of the scarf through the holes 110 of an end of the accessory 105. In other cases, a rope, leather strap, or other type of cord may be used as the bridle 115. In some cases, a single aperture may be provided and the bridle 115 may be knotted or otherwise secured through the single aperture.

The accessory 105 is novel to the marketplace as it uses leverage, straps, and the user's body weight for best positioning and simulated thrusting. In some cases, one end of the accessory 105 may be placed under a surface, such as a pillow, mattress, chair cushion or other surface, allowing the other free end to extend away from the surface, that allows the user to recline on the other end of the accessory 105. Once in position, the user may attach any suction cup based device to the free surface 120 that extends away from the surface. Then, by grabbing the bridle 115 the user can pull the massage device forward for penetration, and release force from the bridle 115 for withdraw. In some cases, the natural bend in the accessory 105 will allow for a 4-5 inch penetration and snap back to original depth, thus allowing for a very natural and controlled rhythm for the user. The accessory 105 may have beveled edges at each edge, thus eliminating sharp edges or corners, reducing any chance for injury. Due to its single form design and no moving parts the accessory is reliable and with little likelihood of possible defects or breakage. It may be offered in multiple color choices and sizes, due to the depth of mattress foam or other surface that may be used to secure the accessory 105 relative to the user.

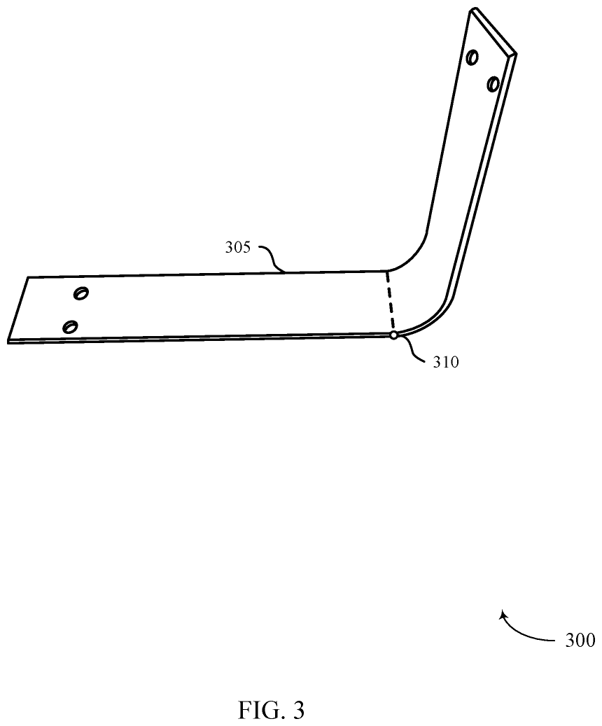

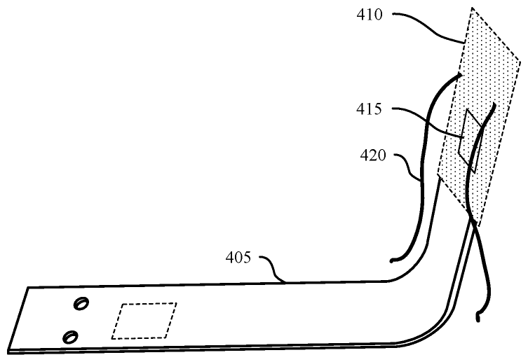

In some cases, as illustrated in FIG. 3, an accessory 305 may include a hinge 310. The hinge 310 may allow the ends of the accessory 305 to be folded toward each other for more convenient transport and storage. In some cases, the hinge 305 may have a latch that may be used to secure the hinge in the open or closed position. In some cases, the hinge 305 may have an associated spring that provides the bias between the first position and the second position of the accessory. In other examples, such as illustrated in FIG. 4, an accessory 405 may include a sleeve 410 (e.g., a lace sleeve) may be slipped over the free end of the accessory 105, and may include a pocket 415 or other securement mechanism that may be used to hold one or more massage devices or other accessories. The sleeve 410 may have one or more holes for access to a massage device, or for threading bridle 420 through the accessory 405. In some cases, the bridle 420 may be attached to the sleeve 410.

While the various aspects described above are discussed and illustrated with an L-shaped accessory with relatively symmetric ends, it will be appreciated that such accessories may be sized with any length ends, and with any suitable width. Further, in some cases, a width of the accessory may be variable to allow for narrower sections adjacent to a user's body (e.g., between a user's legs) and wider sections away from the user's body that may provide enhanced leverage. For example, apertures may be located toward a top of a wider section of the accessory, which may provide enhanced leverage when a bridle that is threaded through the aperture is pulled.

While the invention has been particularly shown and described with reference to various embodiments thereof, it will be readily understood by those skilled in the art that various other changes in the form and details may be made without departing from the spirit and scope of the invention.

What is claimed is:

1. A massage device accessory apparatus, comprising:
a first end having a first massage device securement portion and one or more apertures;
a second end having a second massage device securement portion and one or more apertures; and
an elbow coupled with the first end and the second end,
wherein the elbow, the first end, and the second end have a relaxed first form having an L-shape that is deformable through application of a force to one or more of the apertures to have an elastic deformation to a second form to force a massage device secured to the first massage device securement portion in a first direction relative to a user of the accessory, and is biased to return back to the relaxed first form upon removal of the force.

2. The apparatus of claim 1, further comprising:
a bridle threaded through the one or more apertures of the first end, and wherein the force is applied through pulling on the bridle.

3. The apparatus of claim 2, wherein:
the bridle comprises a scarf, cord, rope, or strap that is threaded through the one or more apertures of the first end.

4. The apparatus of claim 3, wherein:
the second end is configured to be secured relative to the user to allow for movement of the first end toward and away from a desired location of the user's body.

5. The apparatus of claim 1, further comprising:
a sleeve placed around the first end, and wherein the massage device is secured to the sleeve.

6. The apparatus of claim 1, wherein the first end, second end, and elbow are formed from a single piece of elastically deformable material.

7. The apparatus of claim 6, wherein the material comprises acrylic having a thickness between ⅛ inch and ⅜ inch.

8. The apparatus of claim 6, wherein the material comprises a metal that is elastically deformable.

9. The apparatus of claim 1, further comprising:
a hinge coupled between the first end and the elbow, wherein the first end is hangable toward the second end for transport and storage of the apparatus.

10. The apparatus of claim 9, wherein the hinge includes a latch to lock the apparatus into an open or closed position.

11. The apparatus of claim 1, wherein each side of the apparatus has a beveled or radiused edge.
